(19) United States
(12) Patent Application Publication
(10) Pub. No.: US 2010/0082720 A1
(43) Pub. Date: Apr. 1, 2010

(54) CURVE-FITTING METHOD TO CALCULATE COARSE FREQUENCY OFFSET

(75) Inventors: Shue-Lee Chang, San Jose, CA (US); Jun Lu, Saratoga, CA (US); Syang-Myau Hwang, Cupertino, CA (US); Lin Yang, Fremont, CA (US)

Correspondence Address: FRANK F. TIAN, 331-4A THIRD AVENUE, LONG BEACH, NJ, 07740, US

(73) Assignee: LEGEND SILICON CORP., Fremont, CA (US)

(21) Appl. No.: 12/239,789

(22) Filed: Sep. 28, 2008

(51) Int. Cl. G06F 17/10

(52) U.S. Cl. 708/300

(57) ABSTRACT

A method comprising the steps of: providing a known sequence comprising a plurality of data points; and curve-fitting the plurality of data points to calculate coarse frequency offset.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-110.

U.S. patent application Ser. No. ______ with attorney docket number LSFFT-102.

U.S. patent application Ser. No. ______ with attorney docket number LSFFT-104.

U.S. patent application Ser. No. ______ with attorney docket number LSFFT-105.

U.S. patent application Ser. No. ______ with attorney docket number LSFFT-106.

U.S. patent application Ser. No. ______ with attorney docket number LSFFT-107.

### FIELD OF THE INVENTION

The present invention relates generally to digital filters, more specifically the present invention relates to a curve-fitting method to calculate coarse frequency offset in a variable sideband (VSB) communications system.

### BACKGROUND

Electronic equipment and supporting software applications typically involve signal processing. For example, home theater, computer graphics, medical imaging and telecommunications all rely on signal-processing technology. Signal processing requires fast math in complex, but repetitive algorithms. Many applications require computations in real-time, i.e., the signal is a continuous function of time, which need be sampled and converted to digital, for numerical processing. A signal processor has to execute algorithms performing discrete computations on the samples as they arrive. The architecture of a digital signal processor (DSP) is optimized to handle such algorithms. The characteristics of a good signal processing engine typically may include fast, flexible arithmetic computation units, unconstrained data flow to and from the computation units, extended precision and dynamic range in the computation units, dual address generators, efficient program sequencing, and ease of programming.

For wireless implementations, a receiver needs to calculate a frequency offset. A publication, IEEE Trans. on Broadcasting, Vol. 54, No. 1, pp. 131˜139, March 2008, to Jingsong Xia, entitled “A Carrier Recovery Approach for ATSC Receivers”, describes such an implementation. However, according to the publication, after doing frequency acquisition twice, the residual frequency should be able to reduce to less then 1% through out the carrier frequency offset from 100 Hz to 150 k Hz. However, from simulations, the said target is difficult to reach.

Therefore, it is desirous to improve the calculations of a coarse frequency offset.

### SUMMARY OF THE INVENTION

A method for using a curve-fitting to calculate coarse frequency offset is provided.

A method for using a curve-fitting to calculate coarse frequency offset for multi-leveled VSB receiver is provided.

A method for using a curve-fitting to calculate coarse frequency offset for 8-VSB receiver is provided.

A method for using a curve-fitting to calculate coarse frequency offset in advanced television systems committee (ATSC) standard is provided.

A method comprising the steps of: providing a known sequence comprising a plurality of data points; and curve-fitting the plurality of data points to calculate coarse frequency offset.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a generic Phase-differential method in accordance with some embodiments of the invention.

FIG. 1A is an example of a specific Phase-differential method in accordance with some embodiments of the invention.

FIG. 2 is a first experimental result using phase-differential method.

FIG. 2A is a second experimental result using curve fitting method.

FIG. 3 is flowchart in accordance with some embodiments of the invention.

FIG. 4 is an example of a digital receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to using a curve-fitting to calculate coarse frequency offset. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of using known sequences within the guard intervals being used for using a curve-fitting to calculate coarse frequency offset. The non-processor circuits may include, but are not limited to, a radio receiver, a radio transmitter, signal drivers, clock circuits, power source circuits, and user input devices. As such, these functions may be interpreted as steps of a method to using a curve-fitting to calculate coarse frequency offset. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

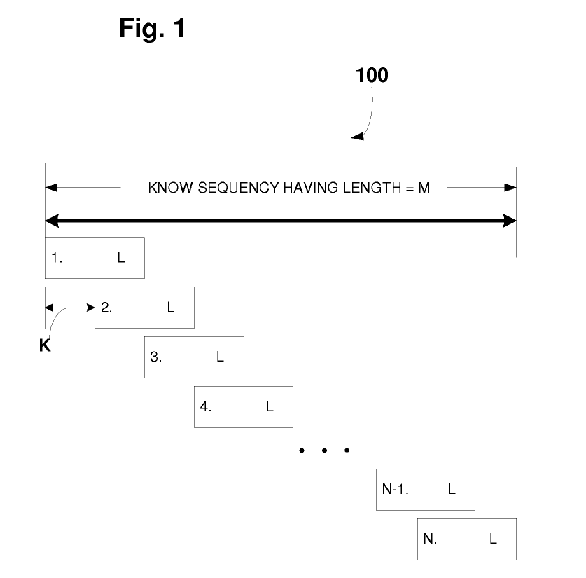

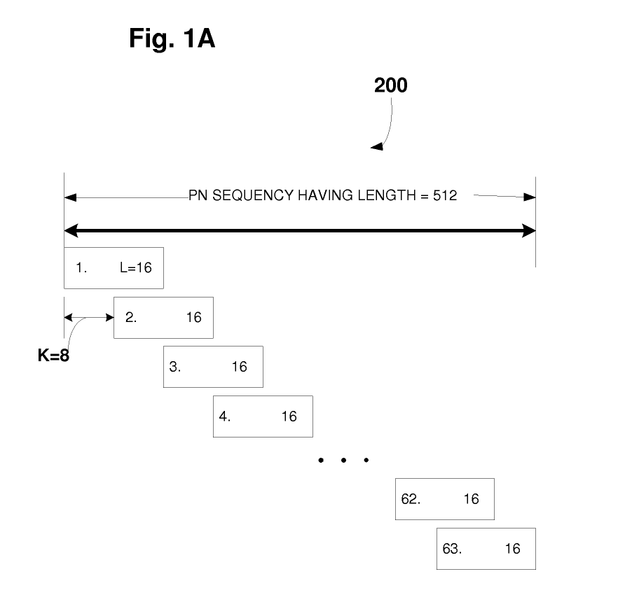

Referring to FIG. 1, a first or generic phase-differential method 100 is shown. A known sequence, such as a pseudo-noise sequence in a communications system, having a length M is provided. N is the number of a set of overlapping blocks, and K is the length of the overlapping. A first run of the phase differential method is performed in equation one:

$$\begin{matrix}phase = [ ( {θ}_{2} - {θ}_{1} ) + ( {θ}_{3} - {θ}_{2} ) + … + ( {θ}_{N} - {θ}_{N - 1} ) ] / ( N - 1 ) \\ where & Equation 1 \\ N = \frac{M - K}{L} + 1 & Equation 1.1\end{matrix}$$

In using equation 1, the residual frequency is found. In turn, a 2^{nd} run of the phase differential method is performed in equation two:

phase=[(θ₄−θ₁)+(θ₅−θ₂)+ . . . +(θ_{N}−θ_{N-3})]/(N−3) Equation 2

Referring to FIG. 1A, a second or a special phase-differential method 200 is shown. A pseudo-noise sequence in an ATSC communications system, having a length equal to 63 multiplied by 8 is provide. The number 63 is obtained by using Equation 1.1 with M=512, L=16, and K=8. Sixty three (63) is the number of a set of overlapping blocks, and 8 is half the length of the overlapping block having the length of 16. Note that the overlapping occurs at the midpoint of the block in this special case. A first run of the phase differential method is performed in equation one:

phase=[(θ₂−θ₁)+(θ₃−θ₂)+ . . . +(θ₆₃−θ₆₂)]/62 Equation 3

using equation 3, the residual frequency is found. In turn, a 2^{nd} run of the phase differential method is performed in equation four:

phase=[(θ₄−θ₁)+(θ₅−θ₂)+ . . . +(θ₆₃−θ₆₀)]/60 Equation 4

There is a second approach to the above frequency acquisition approach, i.e. the curve fitting method. Various curve fitting means are contemplated in the present invention. They comprise Levenberg-Marquardt method, Simplex method, and Linear Regression (linear least-squares) method, etc. Note that other curve fitting means are contemplated in the present invention as well. Also note that Linear Regression is the preferred method or embodiment of the present invention. Various off-the-shelf Curve-fitting methods can be applied. For example, FIG. 1A can use equation three:

phase=curvefit (θ₁, . . . , θ₆₃) equation 3

to curve fit.

Referring to FIG. 1A, a first experimental result using phase-differential method on FIG. 1A is depicted. According to the IEEE publication listed supra, after doing frequency acquisition twice, the residual frequency should be able to reduce to less then 1% through out the carrier frequency offset from 100 Hz to 150 k Hz. However, from simulations, the target is difficult to reach.

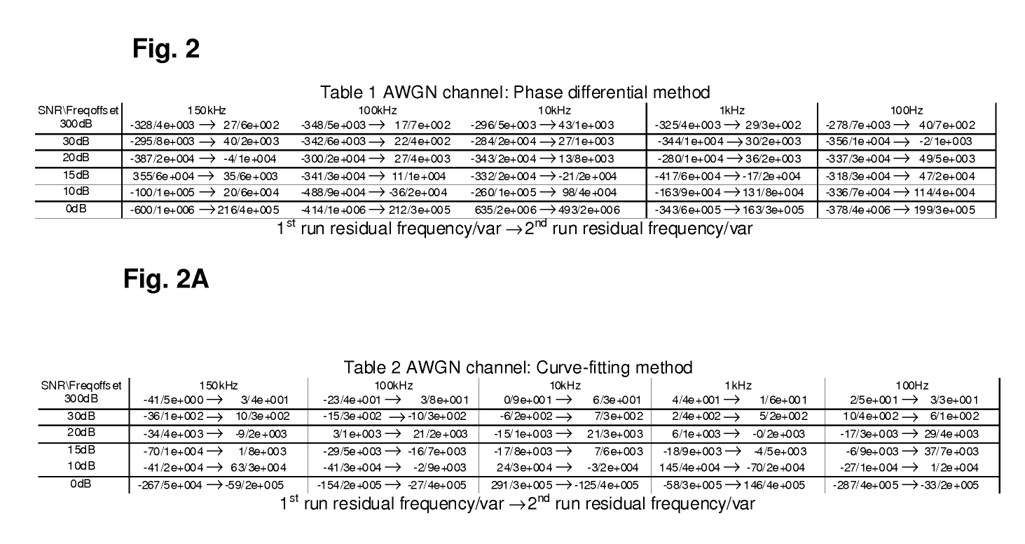

Referring to FIG. 2A, a second experimental result using curve fitting method on FIG. 1A is depicted. Using curve-fitting solution, much better results can be obtained. Comparing to FIG. 2 and FIG. 2A, all the curve-fitting method results have less residual frequency and less variance than phase-differential method. As can be seen, curve-fitting solution has significantly better performance than phase-differential method.

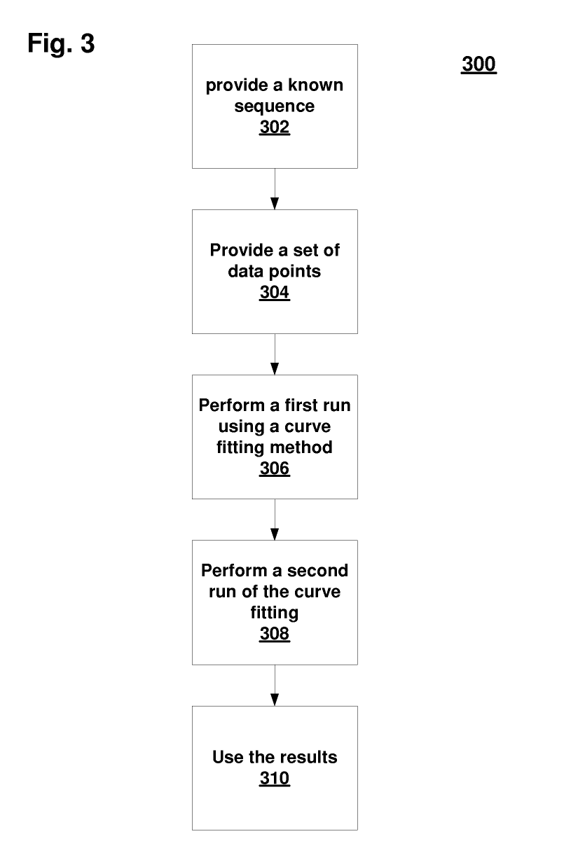

Referring to FIG. 3, flow chart 300 depicting the present invention is shown. A known sequence, such as a pseudo-noise sequence in a communications system, having a length equal to N multiplied by A is provided (Step 302). Known sequence may be transmitted along with unknown data and received by a receiver. The receiver may be a multi-level variable side band (VSB) receiver. N is the number of a set of overlapping blocks, and K is the length of the overlapping. Note that the overlapping occurs at the midpoint of the block in this special case. Provide a set of data points based upon Step 302 (Step 304). Perform a first run using a curve fitting method on the above data points (Step 306). Perform a second run of the curve fitting method on the above data points (Step 308). Use the results of the first and second runs (Step 310). The curve fitting method comprises Levenberg-Marquardt method, Simplex method, or Linear Regression (linear least-squares) method, etc. Various off-the-shelf curve fitting software or methods can be used.

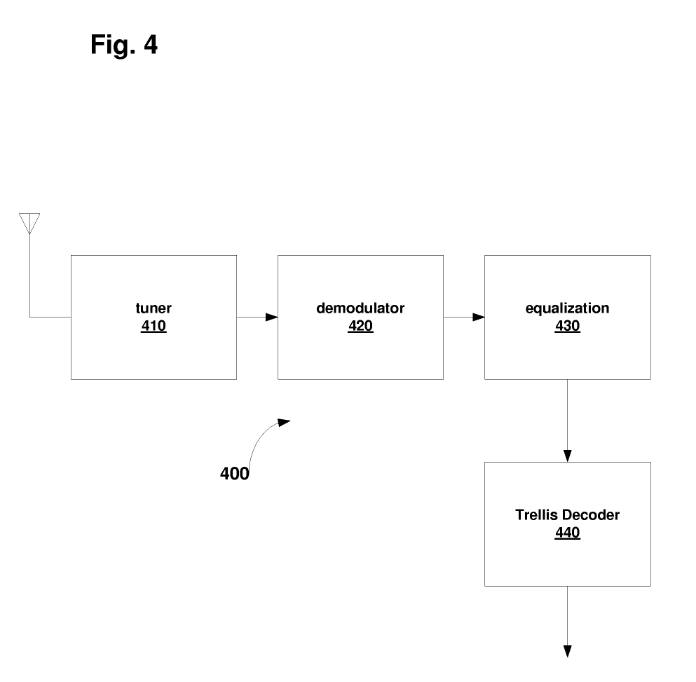

Referring to FIG. 4, a block diagram of a conventional digital television receiver 400, which can process a VSB signal, is shown. The digital television receiver 400 includes a tuner 410, a demodulator 420, an equalizer 430, and a TCM (Trellis-coded Modulation) decoder 440. TCM coding may use an error correction technique, which may improve system robustness against thermal noise. TCM decoding may have more robust performance ability and/or a simpler decoding algorithm. The output signal OUT of the TCM decoder 440 may be processed by a signal processor and output as multimedia signals (e.g., display signals and/or audio signals). The present invention is suitable for application in the equalizer 430. However, the present invention is not limited in its use in receiver 400. Other suitable applications are contemplated by the present invention as well.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method comprising the steps of:
providing a known sequence comprising a plurality of data points; and
curve-fitting the plurality of data points to calculate coarse frequency offset.

2. The method of claim 1 further comprising the step of subdividing the known sequence into N overlapping blocks of equal length.

3. The method of claim 1, wherein the curve-fitting step comprises a first run.

4. The method of claim 1, wherein the curve-fitting step comprises a second run.

5. The method of claim 1, wherein the curve-fitting step comprises Simplex method.

6. The method of claim 1, wherein the curve-fitting step comprises Levenberg-Marquardt method.

7. The method of claim 1, wherein the curve-fitting step comprises or Linear Regression (linear least-squares) method.

8. The method of claim 1 is used in a VSB receiver.

9. The method of claim 1 is used in a 8-VSB receiver.
